(19) United States
(12) Patent Application Publication
(10) Pub. No.: US 2023/0006960 A1
(43) Pub. Date: Jan. 5, 2023

(54) SYSTEMS AND METHODS FOR PROVIDING A PRIVATE SPACE IN A SOCIAL NETWORKING SYSTEM

(71) Applicant: Meta Platforms, Inc., Nenlo Park, CA (US)

(72) Inventor: Robin Maxime Clediere, Lynnwood, WA (US)

(21) Appl. No.: 16/460,143

(22) Filed: Jul. 2, 2019

(51) Int. Cl. H04L 12/58; H04L 29/08

(52) U.S. Cl. CPC H04L 51/32; H04L 67/22

(57) ABSTRACT

Systems, methods, and non-transitory computer-readable media can determine user activity of users of a content sharing system. Whether the user activity of the users satisfies one or more criteria can be determined. A space within which the users can exchange content items can be generated based on satisfaction of the one or more criteria.

### FIELD OF THE INVENTION

The present technology relates to the field of content provision. More particularly, the present technology relates to computerized techniques for providing a private space for exchanging and sharing content within a social networking system.

### BACKGROUND

Today, people often utilize computing devices (or systems) for a wide variety of purposes. Users can use their computing devices to, for example, interact with one another, access content, share content, and create content. In some cases, content items can include postings from users participating in a social network. The postings may include text and media content items, such as images, graphical interchange formats (GIFs), videos, and audio. In some cases, the postings may also include user generated content associated with an event or activity. The postings may be published to the social network for consumption by others.

### SUMMARY

Various embodiments of the present technology can include systems, methods, and non-transitory computer readable media configured to determine user activity of users of a content sharing system. Whether the user activity of the users satisfies one or more criteria can be determined. A space within which the users can exchange content items can be generated based on satisfaction of the one or more criteria.

In some embodiments, a notification can be provided to an invitee of the content sharing system to join the space. The notification can be based on an invitation of one of the users.

In some embodiments, the one or more criteria is satisfied based on the user activity of the users.

In some embodiments, the one or more criteria can include a location criterion. The location criterion can relate locations of the users.

In some embodiments, the one or more criteria can include an event criterion. The event criterion can relate to creation of an event through the content sharing system.

In some embodiments, the satisfaction of the one or more criteria can indicate that the users are participating in a common event.

In some embodiments, the content items can be deleted from the space upon lapse of a predetermined period of time.

In some embodiments, an interface associated with the space can be provided. The interface can allow the users to interact with one another.

In some embodiments, the space permits the users to post content items relating to an event and communicate with one another within the space.

In some embodiments, users associated with user activity that does not satisfy the one or more criteria do not have access to the space.

It should be appreciated that many other features, applications, embodiments, and/or variations of the present technology will be apparent from the accompanying drawings and from the following detailed description. Additional and/or alternative implementations of the structures, systems, non-transitory computer readable media, and methods described herein can be employed without departing from the principles of the present technology.

### BRIEF DESCRIPTION OF THE DRAWINGS

FIG. 1 illustrates an example system, including an example private space module, according to an embodiment of the present technology.

FIG. 2 illustrates an example space generation module, according to an embodiment of the present technology.

FIG. 3 illustrates an example functional block diagram, according to an embodiment of the present technology.

FIG. 4A illustrates an example diagram, according to an embodiment of the present technology.

FIG. 4B illustrates another example diagram, according to an embodiment of the present technology.

FIG. 5 illustrates an example method, according to an embodiment of the present technology.

FIG. 6 illustrates a network diagram of an example system including an example social networking system that can be utilized in various scenarios, according to an embodiment of the present technology.

FIG. 7 illustrates an example of a computer system or computing device that can be utilized in various scenarios, according to an embodiment of the present technology.

The figures depict various embodiments of the present technology for purposes of illustration only, wherein the figures use like reference numerals to identify like elements. One skilled in the art will readily recognize from the following discussion that alternative embodiments of the structures and methods illustrated in the figures can be employed without departing from the principles of the present technology described herein.

### DETAILED DESCRIPTION

### Approaches for Providing a Private Space in Social Networking Systems

People often utilize computing devices (or systems) for a wide variety of purposes. Users can use their computing devices to, for example, interact with one another, access content, share content, and create content. In some cases, content items can include postings from users participating in a social networking system. The postings may include text and media content items, such as images, graphical interchange formats (GIFs), videos, and audio. In some cases, the postings may also include user generated content associated with an event or activity. The postings may be published to the social networking system for consumption by others.

In general, a social networking system can provide users with access to various content items. For example, the social networking system can provide users with access to content items through their content feeds. These content items may include pictures, video, posts, and/or other user generated content items. For example, a content item (or a post) containing one or more images taken by a user at an event can be made accessible to other users (e.g., friends of the user) through their content feeds. In some cases, users can interact with posted content items in content feeds. For example, users may comment, share, like, or otherwise interact with content items posted by other users. In general, for users to have access to and/or interact with content items posted by a particular user, the users and the particular user often share a connection in the social networking system. In some instances, a plurality of users may attend an event and may post content items relating to the event. In such instances, a user assessing content items may be presented with duplicate or similar content items in the user's content feed. For example, assume a wedding in which friends of the bride who are in attendance post various content items (e.g., pictures, videos, etc.) relating to the wedding to the social networking system. In this example, a friend who could not attend the wedding may want to view the posted content items. In this example, the friend may be presented with multiple threads of content items describing the wedding. Moreover, various user interactions between the friends and the bride (e.g., comments, likes, etc.) may be difficult for the friend to track or follow as these interactions may be spread over the multiple threads of content items. As such, conventional approaches to organize and present content items to users in their content feeds may not be helpful or coherent when a plurality of users post content items relating to a common event. Accordingly, conventional approaches may not be effective in addressing these and other problems arising in computer technology.

An improved approach rooted in computer technology overcomes the foregoing and other disadvantages associated with conventional approaches specifically arising in the realm of computer technology. The present technology can generate a private space within a content sharing system, such as a social networking system, through which users can access content items and communicate with one another. The private space can be a space separate from a content feed or other surfaces of the social networking system. For example, users attending a barbeque may collectively post pictures and video of the barbeque to a private space created within the social networking system. In some embodiments, the content items posted to the private space are not displayed or otherwise accessible through other surfaces of the social networking system. In various embodiments, a private space can be generated based on satisfaction of one or more space creation criteria relating to user activity. For example, users may post content items relating to an event to the social networking system. Based on the posting of the content items, the social networking system may determine that the users are attending a common event and may generate a private space for the users to post and exchange content items and communications relating to the event. In some embodiments, once a private space has been generated, users can invite other users to the private space. For example, in one instance, users who are posting content items in a private space can invite other users to post content items to the private space. In another instance, the users can invite other non-posting users to view or interact with the posted content items. The invited users can be apprised of the private space via a notification, such as a notification provided in content feeds of the invited users. In some embodiments, various content items from users can be aggregated in a private space. For example, content items from a first user and content items from a second user can be organized in the private space for presentation. In some embodiments, users may interact with content items posted in a private space. For example, a first user may comment or like a content item posted by a second user in a private space. Likewise, the second user may comment or like a content item posted by the first user in the private space. In some embodiments, users can share content items posted in a private space. For example, a user may select one or more content items from a private space to share the selected content items with others outside the private space, subject to privacy restrictions of the content items. In some cases, the user can share the selected content items via another application, such as a messaging application. More details describing the present technology are provided below.

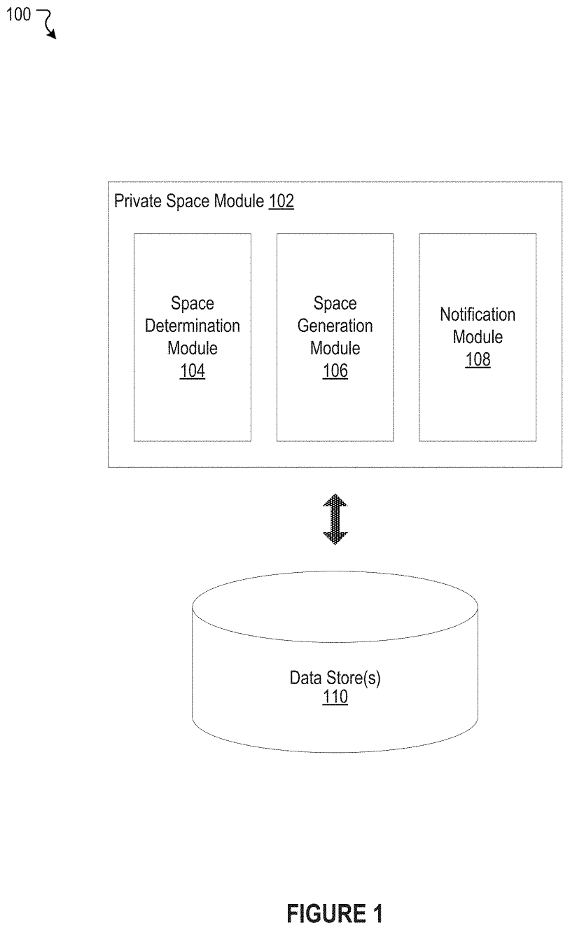

FIG. 1 illustrates an example system 100, including an example private space module 102, according to an embodiment of the present technology. In some embodiments, the private space module 102 can be implemented as part of a content sharing system, such as a social networking system. As shown in the example of FIG. 1, the private space module 102 can include a space determination module 104, a space generation module 106, and a notification module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details.

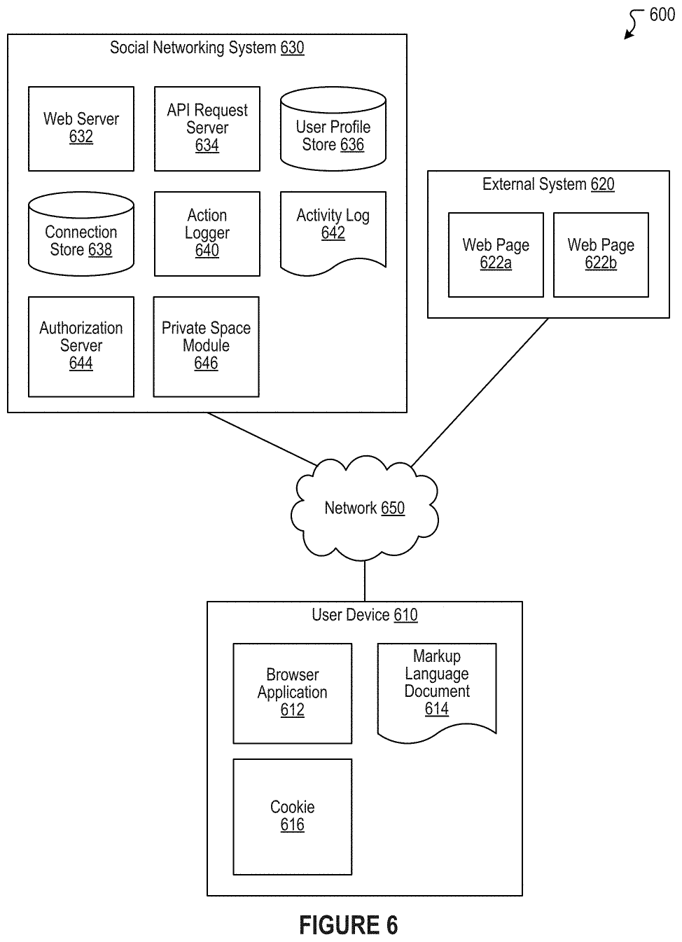

In some embodiments, the private space module 102 can be implemented, in part or in whole, as software, hardware, or any combination thereof. In general, a module as discussed herein can be associated with software, hardware, or any combination thereof. In some implementations, one or more functions, tasks, and/or operations of modules can be carried out or performed by software routines, software processes, hardware, and/or any combination thereof. In some cases, the private space module 102 or at least a portion thereof can be implemented using one or more computing devices or systems that include one or more servers, such as network servers or cloud servers. In some instances, the private space module 102 can, in part or in whole, be implemented within or configured to operate in conjunction with a social networking system (or service), such as the social networking system 630 of FIG. 6. In some instances, the private space module 102 can be, in part or in whole, implemented within or configured to operate in conjunction or be integrated with a client computing device, such as the user device 610 of FIG. 6. The private space module 102 can be implemented as or within a dedicated application (e.g., app), a program, or an applet running on a user computing device or client computing system. The application incorporating or implementing instructions for performing some, or all, functionality of the private space module 102 can be created by a developer. The application can be provided to or maintained in a repository. In some cases, the application can be uploaded or otherwise transmitted over a network (e.g., Internet) to the repository. For example, a computing system (e.g., server) associated with or under control of the developer of the application can provide or transmit the application to the repository. The repository can include, for example, an “app” store in which the application can be maintained for access or download by a user. In response to a command by the user to download the application, the application can be provided or otherwise transmitted over a network from the repository to a computing device associated with the user. For example, a computing system (e.g., server) associated with or under control of an administrator of the repository can cause or permit the application to be transmitted to the computing device of the user so that the user can install and run the application. The developer of the application and the administrator of the repository can be different entities in some cases, but can be the same entity in other cases. It should be understood that many variations are possible.

In some embodiments, the private space module 102 can be configured to communicate and/or operate with the at least one data store 110, as shown in the example system 100. The at least one data store 110 can be configured to store and maintain various types of data. For example, the at least one data store 110 can store information describing various content that has been viewed, accessed, consumed, modified, or created by user or third party entities of the social networking system. In some implementations, the at least one data store 110 can store information associated with the social networking system (e.g., the social networking system 630 of FIG. 6). The information associated with the social networking system can include data about users, third party entities, social connections, social interactions, locations, geo-fenced areas, maps, places, events, pages, groups, posts, communications, content, feeds, account settings, privacy settings, a social graph, and various other types of data. In some implementations, the at least one data store 110 can store information associated with users or third party entities, such as user or third party entity identifiers, user or third party entity information, profile information, user or third party entity specified settings, content produced or posted by users or third party entities, and various other types of user or third party entity data.

In some embodiments, the private space module 102 can be configured to generate a private space based on user activity of users of a social networking system. In general, a private space can be a space or virtual location within the social networking system through which certain users can share and communicate with one another. Content items posted to the private space are not publicly accessible—only users with access to the private space can, for example, view, comment, and/or share the content items posted to the private space. Users can interact with content items posted in the private space. For example, users can comment on or like content items posted by other users in the private space. In some cases, users can interact with other users in the private space. For example, users can message one another in the private space. In some embodiments, a private space can be generated based on user activity of users. In various embodiments, the user activity of the users can include activities relating to the users accessing content items in the social networking system. For example, user activity can include a determined location of a user while the user posts a content item to the social networking system. As another example, user activity can include a determined location of a user while the user comments on a post in the social networking system. In various embodiments, the user activity can include activities performed in the social networking system. For example, a user can plan an event using an event feature of the social networking system. The user can invite other users to the event using the event feature. In this example, user activity can include attendance by users at the event. Many variations are possible. In some embodiments, a private space can be generated when user activity of users satisfies one or more space creation criteria, as discussed in more detail below.

The space determination module 104 can be configured to determine whether to generate a private space based on user activity of users satisfying one or more space creation criteria. The one or more space creation criteria can include, for example, a location criterion, an event criterion, and any other types of suitable criteria. In some embodiments, only users associated with user activity that satisfies the one or more creation criteria may access the private space. Users associated with user activity that does not satisfy the one or more space creation criteria do not have access to the private space. In some embodiments, the space determination module 104 can determine whether to generate a private space based on satisfaction of the location criterion. The location criterion relates to user activity associated with the location of users. For example, in some embodiments, the location criterion can be satisfied when the users participating in an event are posting content items relating to the event to the social networking system and are within a threshold distance from each other. The content sharing system can determine, based on various data (e.g., GPS data, image recognition applied to captured images or videos, etc.), that the users are within a threshold distance of one another. When the location criterion is satisfied, a private space can be generated for the users to post and share content items. As another example, in some embodiments, the location criterion can be satisfied when users are within a threshold distance from a geographical location. A private space can be generated for the users to post and share content items when the users are within the threshold distance from the geographical location. For instance, assume a first user and a second user are attending a wedding and post content items relating to the wedding to the social networking system. In this instance, because the first user and the second user are within a threshold distance from a geographical location associated with the wedding, the location criterion is satisfied and a private space can be generated for the two users to post and share content items relating to the wedding event. In some embodiments, the space determination module 104 can determine whether to generate a private space based on satisfaction of the event criterion. The event criterion relates to user activity associated with creating an event, for example, using a calendar feature of the social networking system. In various embodiments, users can create events (or gatherings) using the calendar feature of the social networking system. For example, a user may create a barbeque event, a picnic event, or a movie event using the calendar feature and invite friends of the user to participate through the social networking system. The satisfaction of the event criterion can be determined based on identifying users who are attending an event created through the social networking system. For example, a user can create a barbeque event through the social networking system. Users attending the barbeque event can be identified by the social networking system based on the users' acceptance of invitations to the barbeque event. When the event criterion is satisfied, a private space can be generated for the users and the user to post and share content items relating to the barbeque event. In some embodiments, a private space is generated upon satisfaction of one criterion or a combination of criteria. Many variations are possible.

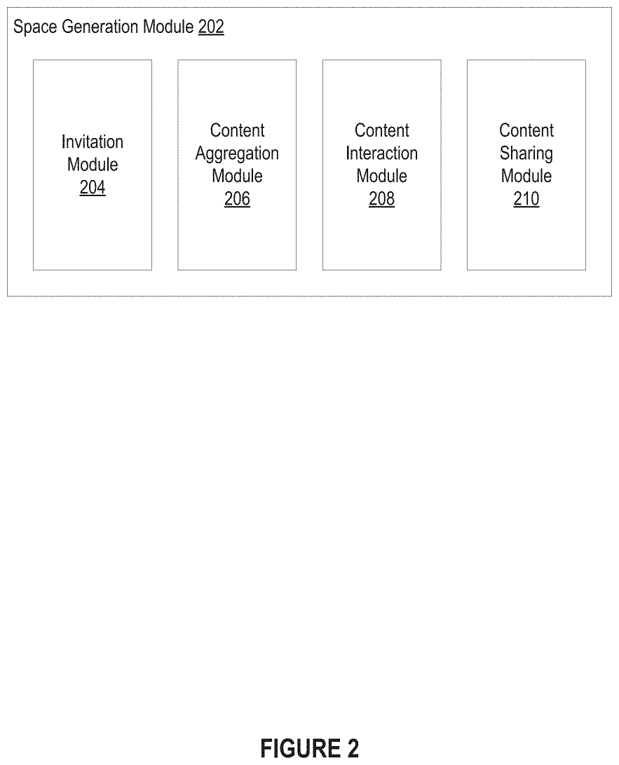

The space generation module 106 can be configured to generate a private space in the social networking system for users. The space generation module 106 can generate the private space based on satisfaction of one or more space creation criteria as determined by the space determination module 104, discussed above. A private space, in various embodiments, can be a page or other virtual location within the social networking system (e.g., separate from a content feed) in which content items and messages can be shared. In some instances, the content items may share a common theme or idea, or in some cases, relate to a common event. In some embodiments, the private space can be accessed by users from their content feeds. In some embodiments, the space generation module 106 can provide an invitation to a user to access content items posted in a private space. In some embodiments, the space generation module 106 can aggregate content items of users. In some embodiments, the space generation module 106 allows users in a private space to interact with content items posted in the private space. In some embodiments, the space generation module 106 allows users to share content items posted in a private space with other users outside of the private space. More details describing the space generation module 106 will be discussed below with respect to FIG. 2.

The notification module 108 can be configured to provide a notification to users that enables the users to access a private space. The notification module 108 can provide the notification to users upon a determination that user activities associated with the users have satisfied the space creation criteria, as discussed above. The notification module 108 can provide a notification to a user that provides access to the private space so the user can, for example, access content items, post content items, interact with content items, exchange messages, etc. in the private space. In some embodiments, a notification providing access to a private space can be presented to a user through a content feed associated with the user. In some embodiments, the notification can be communicated to a user via email, messaging, or other suitable means of communication.

FIG. 2 illustrates an example space generation module 202, according to an embodiment of the present technology. In some embodiments, the space generation module 106 of FIG. 1 can be implemented as the space generation module 202. As discussed, the space generation module 202 can provide a private space in a social networking system. As shown in FIG. 2, the space generation module 202 can include an invitation module 204, a content aggregation module 206, a content interaction module 208, and a content sharing module 210.

The invitation module 204 can be configured to invite users (e.g., invitees) of the social networking system to access content items posted in a private space. The invitation module 205 can invite an invitee to a private space based on a request from a user already participating in the private space to invite the invitee to the private space. For example, a private space for an event can be generated for participants of the event. In this example, a participant can invite other users of the social networking system to the private space. In some cases, the invitation module 204, upon receiving a request from a participant in a private space, can invite an invitee to, for example, post, interact with, or communicate about content items in the private space.

The content aggregation module 206 can be configured to aggregate content items of users in a private space. In some embodiments, once a private space is created, the content aggregation module 206 can aggregate various content items posted by users to the private space. For example, a first user can post content items relating to an event to a private space for sharing. A second user also can post content items relating to the event to the private space. In this example, the content aggregation module 206 can combine, organize, or otherwise aggregate the content items from the first user and the second user in the private space. In some embodiments, the content aggregation module 206 can organize content items based on metadata associated with the content items. For example, content items from a first user may have earlier timestamps (e.g., capture times, post times) than content items from a second user. In this example, the content aggregation module 206 can organize content items in a private space such that the content items are presented in chronological order according to their timestamps. As another example, content items can be organized for presentation through the private space based on which user posted the content items to the private space. Many variations are possible.

The content interaction module 208 can be configured for users to interact with content items posted in a private space. For example, a private space associated with an event may include content items posted by users participating in the event. The users may interact with the content items posted in the private space. For instance, a user may comment on or like a content item posted by a second user, and vice versa. Further, in this instance, the second user may reply to the comment or the like from the first user. In some embodiments, the content interaction module 208 can allow non-posting users to interact with content items posted in a private space. For example, a non-posting user can be invited to the private space. In this example, the non-posting user can interact with (e.g., comment, like, etc.) the content items posted in the private space.

The content sharing module 210 can be configured for users to share content items posted in a private space. In some embodiments, the content sharing module 210 allows a content item posted in the private space to be shared through other surfaces of a social networking system. Such sharing can be subject to the privacy restrictions associated with the content items. For example, while browsing content items in a private space, a user can select one or more content items in the private space for sharing in one or more content feeds that are accessible to users who do not have access to the private space. In some embodiments, the content sharing module 210 allows the user to share content items posted in the private space by using another application. For example, a user can select one or more content items in a private space for sharing using a messaging application. In some embodiments, access to a private space can lapse or be terminated after passage of a predetermined period of time from the generation of the private space or first posting to the private space. Such predetermined period of time can be any selected duration of time, such as an hour, two hours, three hours, a day (e.g., 24 hours), a week, etc. In some embodiments, after passage of the predetermined time, the private space is no longer accessible to users and functionality of the private space is terminated (or expired). In some embodiments, after passage of the predetermined time, the private space is eliminated and no longer exists on the social networking system. Further, content items or messages posted to the private space are automatically deleted and no longer accessible to users after expiration of the private space.

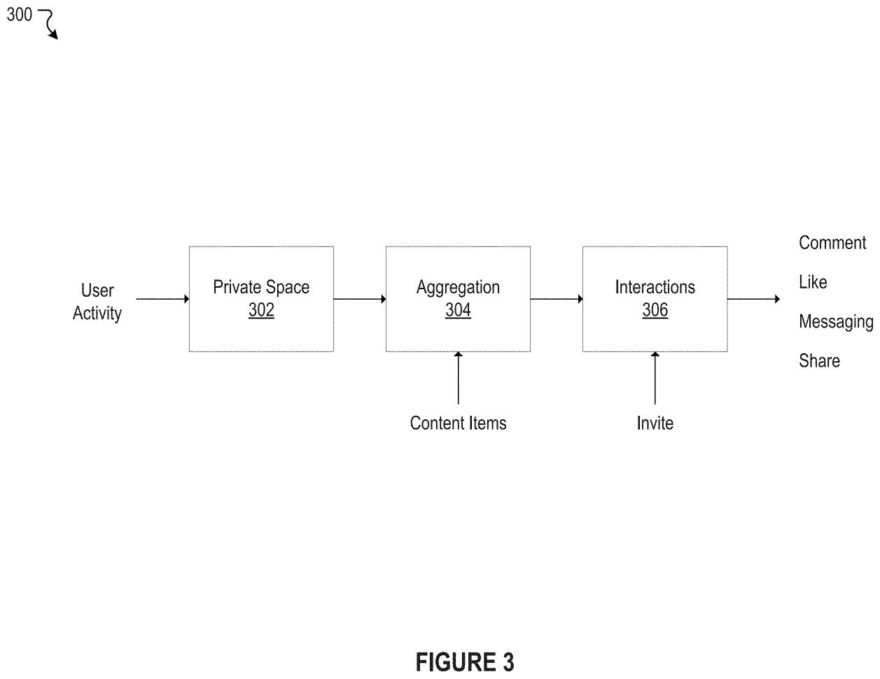

FIG. 3 Illustrates an example functional block diagram 300, according to an embodiment of the present technology. The functionality described in the example block diagram 300 is supported by the private space module 102. A private space within a social networking system can be generated at block 302. The private space can be generated based on user activity of users satisfying space creation criteria. The space creation criteria can include various criteria, such as a location criterion and an event criterion, as discussed above. Once the private space is generated, content items posted by the users can be aggregated at block 304. The content items can be aggregated and, in some cases, organized based on metadata associated with the content items. In various embodiments, the users can interact with content items posted in the private space at block 306. These interactions can include commenting or liking a content item posted in the private space. For example, a user can comment on a photo posted by another user and vice versa. As another example, a user can “like” a photo posted by another user. In some embodiments, the users can message one another in the private space. In some embodiments, content items posted in the private space can be shared through other surfaces of the social networking system subject to privacy restrictions of the content items. For example, the users may select one or more content items and the social networking system can share the selected content items through, for example, one or more content feeds. In some cases, the users may share the selected content items via a messaging application. In some embodiments, the users may invite other users (e.g., invitees) to access the private space. In such embodiments, a notification can be sent to users who are invited to access the private space. Many variations are possible.

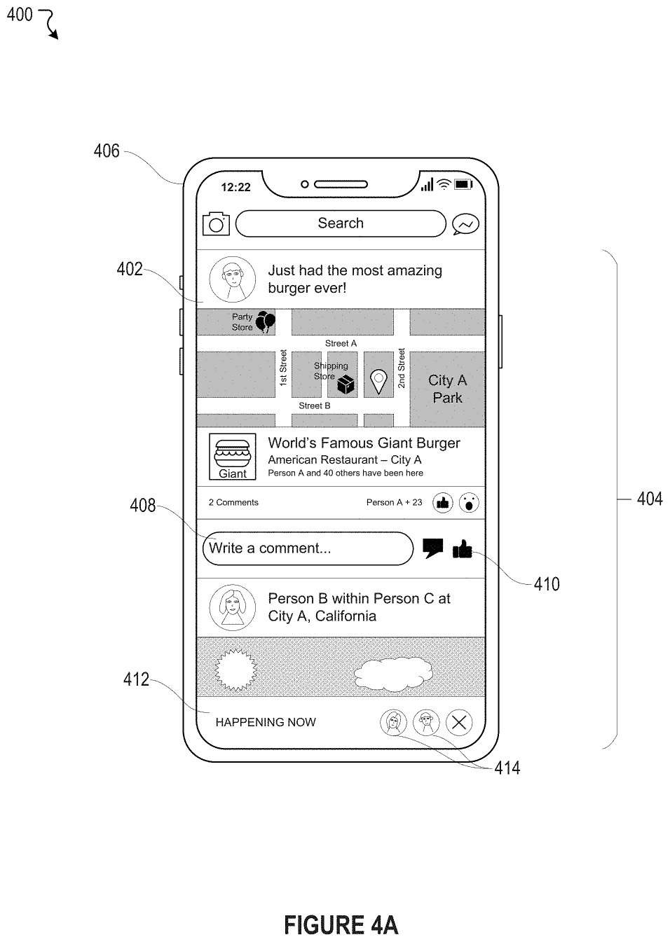

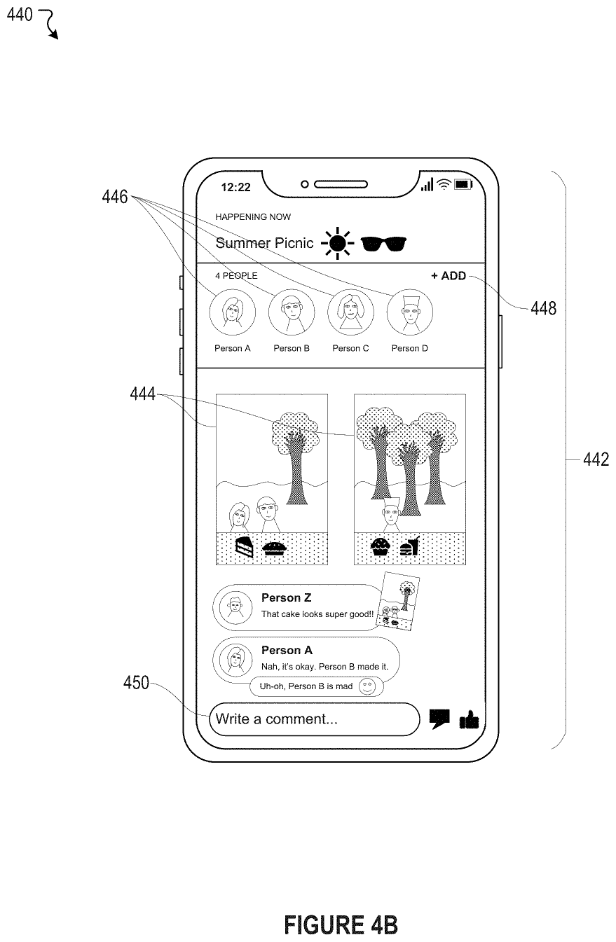

FIG. 4A illustrates an example diagram 400, according to an embodiment of the present technology. This example diagram 400 depicts a scenario supported by the private space module 102 in which a user can access a content item 402 through an application of a content sharing system, such as a social networking system. In particular, the content item can be accessed through a content feed 404 presented on a display of a computing device 406 (e.g., a smartphone, a tablet, etc.). In some embodiments, while the user is accessing content items through the content feed 404, the social networking system can provide a notification 412 to the user that a private space has been generated (e.g., “Happening Now”). The private space is generated upon satisfaction of space creation criteria relating to user activities of users 414 connected to the user in the social networking system. The private space can correspond to an event, and the users 414 can post content items related to the event to the private space. The user can access the private space by selecting the notification 412. For example, the user may touch or press the notification 412 to access the private space.

FIG. 4B illustrates another example diagram 440, according to an embodiment of the present technology. This example diagram 440 depicts a scenario in which a user has selected a notification of a private space (e.g., the notification 412 of FIG. 4A) presented in a content feed of a social networking system (e.g., the content feed 404 of FIG. 4A). In some embodiments, upon a user selection (e.g., touch or press) of the notification, the user is provided access to a private space 442 corresponding to an event (e.g., “Summer Picnic”). The private space 442 contains various content items 444 relating to the event posted by users 446 who have joined the private space. In some embodiments, the user can be connected as friends to one or more of the users 446 in the social networking system. In various embodiments, the content items 444 posted to the private space 442 can include images or video, or a combination both. In some embodiments, the user and the users 446 can communicate about the content items 444 posted to the private space 442 through a messaging interface 450. For example, the user can comment on an image (e.g., “That cake looks super good!!) through the messaging interface 450. As another example, one of the users 446 may comment (e.g., “Nah, it's okay. Person B made it”) in response to the comment made by the user. In some cases, the user and the users 446 may like the content items 444. In some embodiments, the private space 442 can be ephemeral and thus only accessible or functional for a predetermined period of time. Furthermore, in some embodiments, the user or the users 446 may invite other users (e.g., invitees) of the social networking system to the private space 442 by selecting an element 448. Many variations are possible.

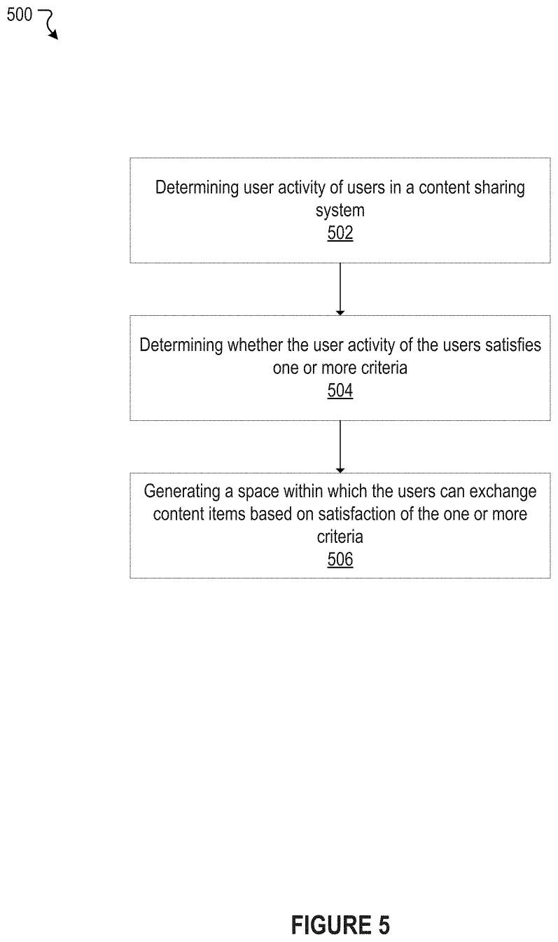

FIG. 5 illustrates an example method 500, according to an embodiment of the present technology. It should be appreciated that there can be additional, fewer, or alternative steps performed in similar or alternative orders, or in parallel, within the scope of the various embodiments discussed herein unless otherwise stated.

At block 502, user activity of users in a content sharing system can be determined. At block 504, whether the user activity of the users satisfies one or more criteria can be determined. At block 506, a space within which the users can exchange content items can be generated based on satisfaction of the one or more criteria.

It is contemplated that there can be many other uses, applications, and/or variations associated with the various embodiments of the present technology. For example, in some cases, user can choose whether or not to opt-in to utilize the present technology. The present technology can also ensure that various privacy settings and preferences are maintained and can prevent private information from being divulged. In another example, various embodiments of the present technology can learn, improve, and/or be refined over time.

### Social Networking System—Example Implementation

FIG. 6 illustrates a network diagram of an example system 600 that can be utilized in various scenarios, in accordance with an embodiment of the present technology. The system 600 includes one or more user devices 610, one or more external systems 620, a social networking system (or service) 630, and a network 655. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 655. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 655. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 655, which may comprise any combination of local area and/or wide area networks, using wired and/or wireless communication systems.

In one embodiment, the network 655 uses standard communications technologies and protocols. Thus, the network 655 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 655 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 655 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 655. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 655.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, media content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and media content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 655. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 655, and the API request server 634 receives the API request. The API request server 634 processes the request by calling an API associated with the API request to generate an appropriate response, which the API request server 634 communicates to the external system 620 via the network 655. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a private space module 646. The private space module 646 can be implemented with the private space module 102 of FIG. 1. In some embodiments, one or more functionalities of the private space module 646 can also be implemented in the user device 610.

### Hardware Implementation

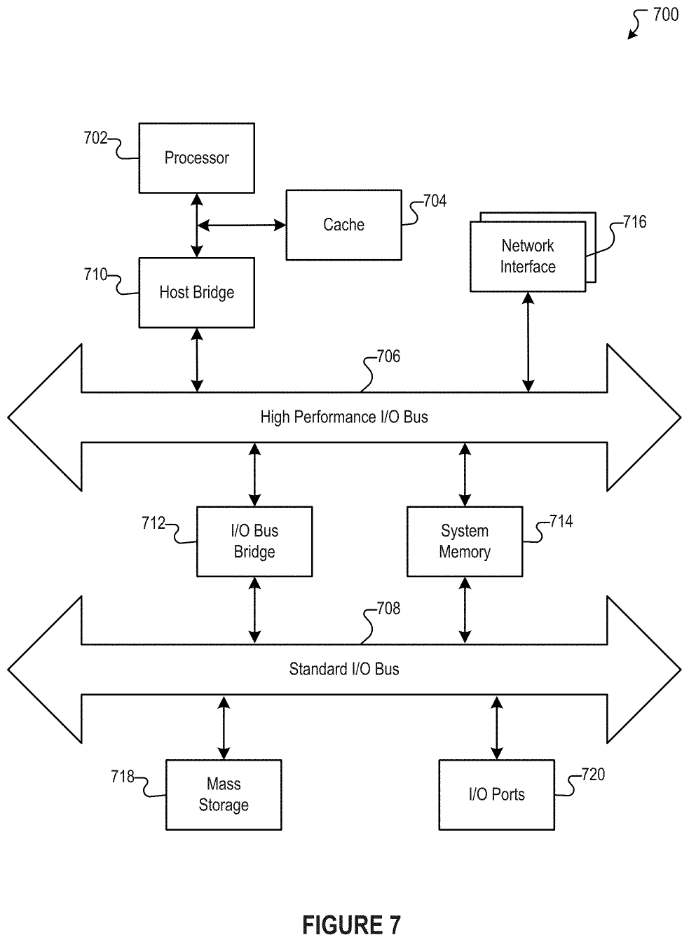

The foregoing processes and features can be implemented by a wide variety of machine and computer system architectures and in a wide variety of network and computing environments. FIG. 7 illustrates an example of a computer system 700 that may be used to implement one or more of the embodiments described herein in accordance with an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 720, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 600 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

1. A computer-implemented method comprising:
determining, by a computing system, user activity of first users and second users of a content sharing system, wherein the user activity includes posts of content items;
determining, by the computing system, the user activity of the first users satisfies criteria based on i) locations associated with the first users that are within a threshold distance of a geographical location associated with an event in which the first users have previously indicated intent to participate and ii) the content items that are posted by the first users are related to the event;
aggregating, by the computing system, the content items i) that are posted by the first users that satisfy the criteria and ii) that are related to the event;
generating, by the computing system, a space for the event that includes the content items that are posted by the first users that satisfy the criteria and that are related to the event
allowing, by the computing system, content to be posted within the space by the first users;
preventing, by the computing system, the second users who fail to satisfy the criteria from access to the space;
subsequent to the preventing, allowing, by the computing system, at least one of the second users to access the space in response to an invitation from at least one of the first users, wherein the at least one of the second users invited to the space is prevented from posting content items to the space; and
preventing, by the computing system, access to the space and the content items posted within the space for the event based on a lapse of a selected period of time from when a first content item is posted within the space.

2. The computer-implemented method of claim 1, further comprising:
providing, by the computing system, a notification to an invitee of the content sharing system to join the space, the notification based on an invitation of one of the first users.

3. The computer-implemented method of claim 1, wherein the content items that are posted by the first users that satisfy the criteria and that are related to the event are organized in the space based on metadata.

4. The computer-implemented method of claim 1, wherein the criteria includes acceptance of an invitation to the event.

5. The computer-implemented method of claim 1, wherein the event was created through the content sharing system.

6. The computer-implemented method of claim 1, further comprising:
providing, by the computing system, a notification that the space has been generated to a user of the first users that satisfies the criteria, wherein the notification is provided while the user has access to a content feed.

7. The computer-implemented method of claim 1, wherein the content items are deleted from the space upon lapse of a predetermined period of time.

8. The computer-implemented method of claim 1, further comprising:
providing, by the computing system, an interface associated with the space allowing the first users to interact with one another.

9. The computer-implemented method of claim 1, wherein the first users can share messages based on satisfaction of the criteria and the messages are deleted from the space upon lapse of a predetermined period of time.

10. The computer-implemented method of claim 1, wherein other users associated with user activity that does not satisfy the criteria do not have access to the space without an invitation from one or more of the first users.

11. A computing system comprising:
at least one processor; and
a memory storing instructions that, when executed by the at least one processor, cause the computing system to perform:
determining user activity of first users and second users of a content sharing system, wherein the user activity includes posts of content item;
determining the user activity of the first users satisfies criteria based on i) locations associated with the first users that are within a threshold distance of a geographical location associated with an event in which the first users have previously indicated intent to participate and ii) the content items that are posted by the first users are related to the event;
aggregating the content items i) that are posted by the first users that satisfy the criteria and ii) that are related to the event;
generating a space for the event that includes the content items that are posted by the first users that satisfy the criteria and that are related to the event
allowing content to be posted within the space by the first users;
preventing the second users who fail to satisfy the criteria from access to the space;
subsequent to the preventing, allowing at least one of the second users to access the space in response to an invitation from at least one of the first users, wherein the at least one of the second users invited to the space is prevented from posting content items to the space; and
preventing access to the space and the content items posted within the space for the event based on a lapse of a selected period of time from when a first content item is posted within the space.

12. The computing system of claim 11, wherein the instructions cause the computing system to further perform:
providing a notification to an invitee of the content sharing system to join the space, the notification based on an invitation of one of the first users.

13. The computing system of claim 11, wherein the content items that are posted by the first users that satisfy the criteria and that are related to the event are organized in the space based on metadata.

14. The computing system of claim 11, wherein the criteria includes acceptance of an invitation to the event.

15. The computing system of claim 11, wherein the event was created through the content sharing system.

16. A non-transitory computer-readable storage medium including instructions that, when executed by at least one processor of a computing system, cause a computing system to perform a method comprising:
determining user activity of first users and second users of a content sharing system, wherein the user activity includes posts of content items;
determining the user activity of the first users satisfies one or more criteria based on i) locations associated with the first users that are within a threshold distance of a geographical location associated with an event in which the first users have previously indicated intent to participate and ii) the content items that are posted by the first users are related to the event;
aggregating the content items i) that are posted by the first users that satisfy the criteria and ii) that are related to the event;
generating a space for the event that includes the content items that are posted by the first users that satisfy the criteria and that are related to the event
allowing content to be posted within the space by the first users;
preventing the second users who fail to satisfy the criteria from access to the space;
subsequent to the preventing, allowing at least one of the second users to access the space in response to an invitation from at least one of the first users, wherein the at least one of the second users invited to the space is prevented from posting content items to the space; and
preventing access to the space and the content items posted within the space for the event based on a lapse of a selected period of time from when a first content item is posted within the space.

17. The non-transitory computer-readable storage medium of claim 16, wherein the instructions when executed cause the computing system to further perform:
providing a notification to an invitee of the content sharing system to join the space, the notification based on an invitation of one of the first users.

18. The non-transitory computer-readable storage medium of claim 16, wherein the content items that are posted by the first users that satisfy the criteria and that are related to the event are organized in the space based on metadata.

19. The non-transitory computer-readable storage medium of claim 16, wherein the criteria includes acceptance of an invitation to the event.

20. The non-transitory computer-readable storage medium of claim 16, wherein the event was created through the content sharing system.
